(19) United States
(12) Patent Application Publication
(10) Pub. No.: US 2009/0089564 A1
(43) Pub. Date: Apr. 2, 2009

(54) Protecting a Branch Instruction from Side Channel Vulnerabilities

(76) Inventors: Ernie F. Brickell, Portland, OR (US); Sergiu Ghetie, Hillsboro, OR (US); Shay Gueron, Haifa (IL); Adil Karrar, Santa Clara, CA (US); Francis X. McKeen, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/951,999

(22) Filed: Dec. 6, 2007

Related U.S. Application Data
(60) Provisional application No. 60/873,537, filed on Dec. 6, 2006.
(60) Provisional application No. 60/873,614, filed on Dec. 6, 2006.

(51) Int. Cl. G06F 9/38

(52) U.S. Cl. 712/239; 712/E09.045

(57) ABSTRACT

Embodiments of an invention to protection a branch instruction from side channel vulnerabilities are described. In one embodiment, a method includes receiving a request to modify the operation of a processor to protect against side channel attacks, and modifying branch prediction operation in response to the request.

### REFERENCE TO PRIOR PROVISIONAL APPLICATIONS

This application claims the benefit of U.S. Provisional Application No. 60/873,537, filed Dec. 6, 2006, and U.S. Provisional Application No. 60/873,614 filed Dec. 6, 2006.

### BACKGROUND

1. Field

The present invention relates generally to computer security and, more specifically, to mitigating side channel attacks based on branch prediction activity or other timing considerations in a processor.

2. Description

There are reports of software side channel vulnerabilities in which an adversarial process can determine information about a target process because of the resource usage of the target process. Some side channel attacks involve the use of information caused by branch prediction. Branch prediction is a common feature of modern processors. It provides a mechanism for hardware to predict which branch a process is likely to take. If the prediction is correct, then the execution is faster. The processor stores information it learns from predictions and miss-predictions to help it predict with more accuracy the next time this branch occurs. For some software, the branch prediction may cause the software to behave differently, with, for example, different execution times, depending upon secret data in the software. For some software, the storage of branch prediction information may be dependent upon secret data in the software, and the differences may cause some other process to behave differently. In either case, information about secret data could be leaked through this side channel.

New theories for attacking the security of computer systems have been proposed. These theories are sometimes called Branch Prediction Attacks (BPA) and Simple Branch Prediction Attacks (SBPA). See Onur Aciiçmez, [symbol] etin Koç and Jean-Pierre Seifert, “Predicting Secret Keys via Branch Prediction”, available on the Internet at http:**eprint.iacr.org*2006*288 (the “/”s have been replaced with “*”s herein) (accepted to the upcoming Rivest/Shamir/Adleman (RSA) 2007 conference); and Onur Aciiçmez, [symbol] etin Kook and Jean-Pierre Seifert, “on the Power of Simple Branch Prediction Analysis”, available on the Internet at http:**cryptome.org*sbpa*sbpa.htm (the “/”s have been replaces with “*”s herein)

The papers showed how an unprivileged spy program can discover a private RSA key by using branch prediction leaks during the Square-and-Multiply (S&M) modular exponentiation procedure. The results were demonstrated on OpenSSL version 9.7 (an open source implementation of the Secure Sockets Layer (SSL) and Transport Layer Security (TLS) protocols). Careful reading of these papers leads to the conclusion that branch prediction attacks can be extended beyond the particular example of modular exponentiation in OpenSSL 9.7. In fact the OpenSSL version 9.8 mitigations against cache attacks do not protect against the new threat. Moreover, it turns out that one of the added mitigations actually opened a door to a branch prediction attack.

New mitigations to side channel attacks are needed to deter attempts to subvert the security of a computer system.

### BRIEF DESCRIPTION OF THE DRAWINGS

The features and advantages of the present invention will become apparent from the following detailed description of the present invention in which:

FIG. 1 is a block diagram of an apparatus according to an embodiment of the present invention; and

FIGS. 2-6 are flow diagrams of methods according to embodiments of the present invention.

### DETAILED DESCRIPTION

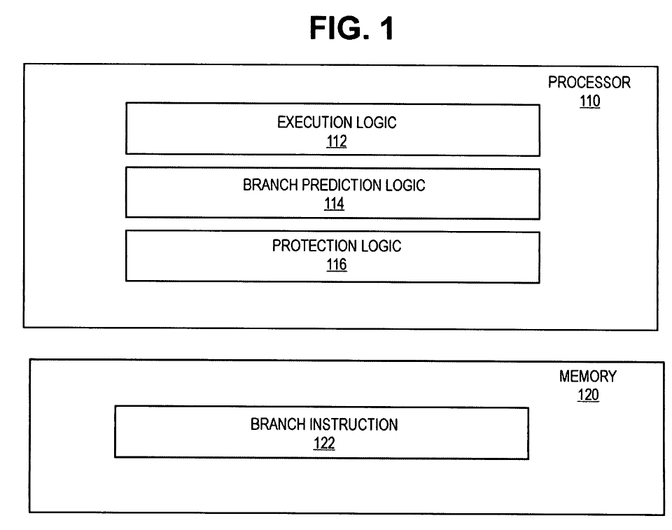

In embodiments of the present invention, the micro-architecture of a processor (e.g., processor 110 in FIG. 1) may be modified to mitigate the leakage of information through the use of branch prediction.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

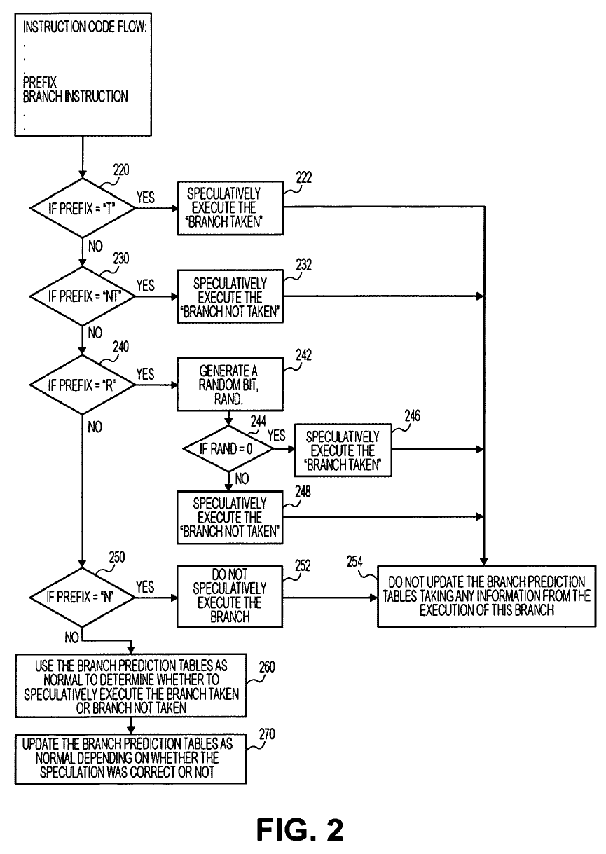

In one embodiment, the execution of the branch instructions (e.g., branch instruction 122 in FIG. 1) may be modified so that the software may specify that for a specific branch that the hardware (e.g. branch prediction logic 114) should speculate that the branch should be taken or that the branch should not be taken (ergo, 222 and 232 in FIG. 2), and that the branch tables that store information about branches should not be updated (e.g., 254 in FIG. 2). One way to modify the branch instructions is to use a prefix to the instruction that indicates which branch to take (e.g. 220 and 230 in FIG. 2) and to not update the branch tables (e.g., 254 in FIG. 2). There are several types of branch instructions in the current Intel Architecture for Intel processors. Details about how these are handled are included below.

In one embodiment, the execution of the branch instruction may be modified so that the software may specify that hardware should choose randomly which branch to speculatively execute (e.g., 242 to 246 in FIG. 2), and to also not update the branch tables (e.g., 254 in FIG. 2). One way to do this is by having a prefix that indicates that the hardware make a random choice of Taken or Not Taken for the branch (e.g. 240 in FIG. 2), to speculatively execute that branch, and to not update the branch tables with any information from this branch (ergo, 254 in FIG. 2).

In one embodiment, the prefix to a branch instruction may specify that hardware should not speculatively execute anything (e.g., 250 in FIG. 2), neither the branch taken or the branch not taken.

A description of the use of the branch specific prefixes for different branch instructions is as follows.

Two branch-specific prefixes, Taken (T) and Not Taken (NT), are associated with conditional indirect, direct, and return branches.

Conditional Branches:

At fetch time, prefixes always dictate that the Branch Prediction Unit (BPU) target array misses and therefore the BPU cannot make a prediction regarding the conditional branch. Branch Address Calculator (BAG) must always make a static prediction based on the prefix and disregard any other static branch prediction overriding mechanisms (L2 predictor). BAG will assert BAClear (signal) to inform the Front End to start fetching from the target of the statically predicted taken conditional branch according to the prefix.

At execution time, when the conditional branch resolution is known and if the conditional branch carried either of the two prefixes the BPU will not update any of its arrays with information regarding these branches (i.e., it will not allocate any new array entries or update existing ones).

Indirect Branches:

At fetch time, prefixes always dictate that the BPU target array misses and therefore the BPU cannot make a prediction regarding the indirect branch.

At execution time, when the indirect branch address is known and if the indirect branch carried either of the two prefixes the BPU will not update any of its arrays with information regarding these branches (i.e., it will not allocate any new array entries or update existing ones including return stack buffer (RSB)).

Direct Branches (Except for Returns):

At fetch time, prefixes always dictate that the BPU target array misses and therefore the BPU cannot make a prediction regarding the direct branch. For calls the BPU will not update the return stack buffer for any call instruction calling either of the two prefixes, BAC will always make a taken prediction and must disregard any other static branch prediction overriding mechanisms. BAC will always assert BAClear (signal) to inform the Front End to start fetching from the target of the always predicted taken branch if it carries either of the two prefixes.

At execution time, for direct branch with either of the two prefixes the BPU will not update any of its arrays with information regarding these branches (i.e., it will not allocate any new array entries or update existing ones including the RSB).

Return Instruction Branches:

At fetch time prefixes always dictate that the BPU target array misses and therefore the BPU cannot make a prediction regarding any return instruction branch.

At execution time when the return instruction branch address is known and if the return instruction branch carried either of the two prefixes the BPU will not update any of its arrays with information regarding these branches (i.e. it will not allocate any new array entries or update existing ones including RSB).

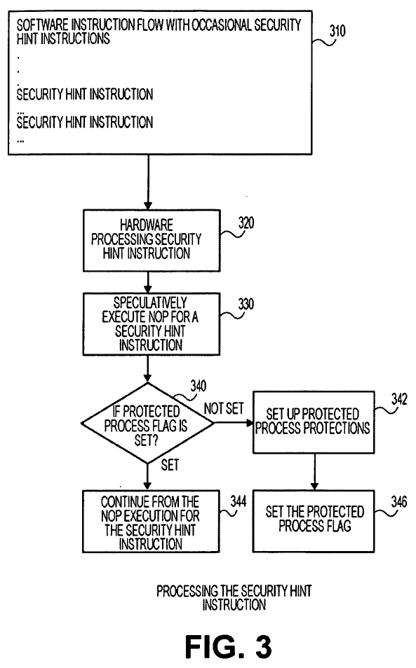

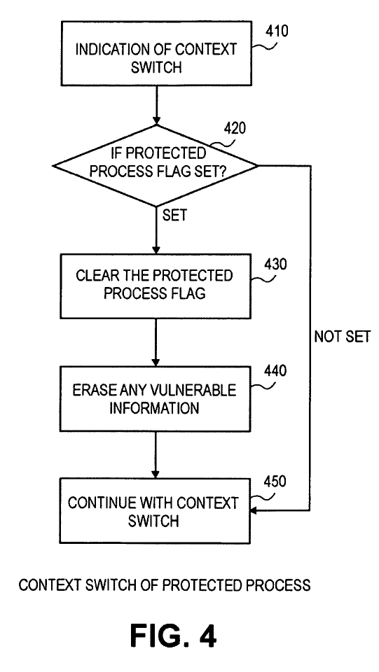

Another embodiment uses a new type of instruction, called a Security Hint instruction. The Security Hint instruction informs the hardware that the process executing wants to be protected from branch prediction side channels (e.g. 310 in FIG. 3). The hardware would then put into place protections for that process from branch prediction side channels (e.g., 320 in FIG. 3). The hardware would set a flag, called a Protected Process Flag, to indicate that the protections were in place (egg, 346 in FIG. 3). Subsequent executions of the Security Hint could be treated as a NOP (e.g., 330 in FIG. 3). This could be executed rapidly using a mechanism like fast branch to speculatively execute the Security Hint as a NOP. When there is a context switch (e.g.; 410 in FIG. 4) or if the process is migrated to another hardware thread, then the protections would be removed (e.g., 430 in FIG. 4), and any sensitive data removed (e.g. 440 in FIG. 4).

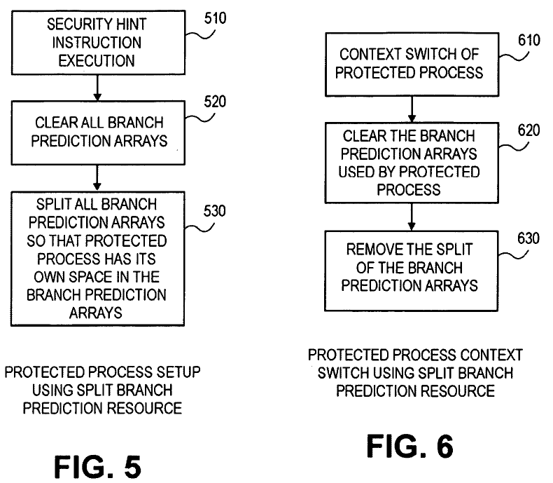

The Security Hint instruction indicates that a process wants to be protected (e.g., 510 in FIG. 5). It may want to be protected from other side channels that exploit shared tables. One method to protect against this is for the hardware to take action to split or otherwise protect many tables in the processor that use shared resources (e.g. 530 in FIG. 5). Additionally, these tables can be erased upon executing a security hint when the Protected Process Flag is not set (e.g., 520 in FIG. 5), and may also be erased (e.g., 620 in FIG. 6) upon a context switch of a protected process (e.g., 610 in FIG. 6).

In one embodiment, a modified instruction instead of a security hint instruction may be used to indicate a protected process. In this method, a new instruction could be formed that combines the functionality of a Security Hint instruction with an existing instruction. For example, there could be a new branch instruction that would execute just like an existing branch instruction except that if the Protected Process Flag was not set, then an exception would be raised, and the exception handier could set the Protected Process Flag and put the protections from branch predictions and other side channels in place. The flag may be set according to any known approach, such as was taught in a pending application entitled “Method and Apparatus for Preventing Side Channel Attacks.” Ser. No. 11/513,871, filed Aug. 31, 2006, and assigned to the same assignee as the present application.

In one embodiment, the hardware generates the exception at the time the instruction is fetched from memory and a new process has been invoked. The exception is sent down the pipeline in the same manner as an instruction stream page fault would be sent. When the exception reaches the re-order buffer (ROB), the exception is taken and serviced by the microcode. The microcode would erase the branch predictor.

One key difference between the earlier filed application, Ser. No. 11/513,871, is that in embodiments of the present invention, the hardware generates the exception when the process change occurs. It does not wait until a trusted process is encountered but instead generates the exception when the new IP is dispatched when the process is changed.

In addition to the branch prediction items mentioned below it should be clear to one familiar with the art that a similar mechanism could provide for a clear of the instruction cache or other state which may be kept in the processor.

Frequency of Security Hint Instructions

The software writer may place Security Hint instructions frequently in the code, particularly assuring that it is placed before instructions that could leak information through side channels. It is not always necessary to place the Security Hint immediately before such instructions. The software writer may analyze whether significant side channel information could be leaked if a context switch happened after the Security Hint instruction, and before an instruction that could leak information. This may be used to analyze the frequency of the Security Hint instructions.

Examples of protections for a process that has executed a Security Hint instruction are shown below. These mechanisms are mutually exclusive methods of protecting against the side channel security vulnerabilities using security hint instructions.

Splitting Branch Prediction Resources:

Arming the Security Hints:
A security hint instruction executed periodically will be treated as a NOP instruction if the branch prediction resources have been previously split (by a previous execution of the same instruction through a mechanism like a fast branch that is resolved at issue time).
When the hint instruction is executed for the first time on a logical processor it will rendezvous both logical processors belonging to the same core, clear all the branch prediction mechanism arrays (BPU arrays. BAC arrays, etc.) and put the branch prediction mechanism arrays in a thread split mode. In this mode the threads do not share any of the branch prediction mechanism arrays. This could be accomplished by adding the thread ID to the branch address for tagless arrays or by including the thread ID in the branch prediction array sets for arrays employing tags. This instruction will also set the fast branch flag used by subsequent execution of the same instruction.

Context Switch Disarming:
Any process change as indicated by a change in the value of CR3 of a previously armed thread will unconditionally rendezvous all logical processors on the same core and will only clear its own branch prediction mechanisms arrays and the associated fast branch flag. If all the other logical processors on the same core are not armed, the branch prediction mechanism arrays will be put in shared mode. In this mode, the threads will share some or all of the branch prediction mechanism arrays. If any of the other logical processors on the same core are still armed, the branch prediction mechanisms will be kept in split mode.

Thread-Migration Disarming:
Any thread migration switch indicated by separate hint instruction executed by the OS Kernel (thread switch handler) will act similarly to a regular context switch based on CR3 changed if the logical processor was previously (indicated by the fast branch flag) or else the hint instruction will be treated like a NOP instruction.

Disabling Branch Prediction Thread Specific:

Arming the Security Hints:
A security hint instruction executed periodically will be treated as a NOP instruction if the branch prediction resources have been previously disabled for this particular thread (by a previous execution of the same instruction through a mechanism like a fast branch that is resolved at issue time).
When the hint instruction is executed for the first time on a logical processor it will disable the branch prediction mechanism arrays for this particular thread. In this mode the threads do not share any of the branch prediction mechanism arrays. This could be accomplished by setting a thread specific disable flag for the branch prediction mechanism arrays. This instruction will also set the fast branch flag used by subsequent execution of the same instruction.

Context Switch Disarming:
Any process change as indicated by a change in the value of CR3 of a previously armed thread will enable the branch prediction mechanisms for this particular thread.

Thread Migration Disarming:
Any thread migration switch indicated by separate hint instruction executed by the OS Kernel (thread switch handier) will act similarly to a regular context switch based on CR3 changed if the logical processor was previously (indicated by the fast branch flag) or else the hint instruction will be treated like a NOP instruction.

Disabling Branch Prediction Core (all Threads) Specific:

Arming-the-Security Hints:
A security hint instruction executed periodically will be treated as a NOP instruction if the branch prediction resources have been previously disabled for all threads belonging to the same core (by a previous execution of the same instruction through a mechanism like a fast branch that is resolved at issue time).
When the hint instruction is executed for the first time on a logical processor it will rendezvous all logical processors belonging to this core and disable the branch prediction mechanism arrays for all threads on the core. This could be accomplished by setting a core specific disable flag for the branch prediction mechanism arrays. This instruction will also set the fast branch flag used by subsequent execution of the same instruction.

Context Switch Disarming:
Any process change as indicated by a change in the value of CR3 of a previously armed thread will unconditionally rendezvous all logical processors on the same core. If all the other logical processors on the same core are not armed, the branch prediction mechanism arrays will be armed. If any of the other logical processors on the same core are still armed, the branch prediction mechanisms will be kept disabled.

Thread Migration Disarming:
Any thread migration switch indicated by separate hint instruction executed by the OS Kernel (thread switch handler) will act similarly to a regular context switch based on CR3 changed if the logical processor was previously (indicated by the fast branch flag) or else the hint instruction will be treated like a NOP instruction.

Hashing the Branch Prediction Tables:

The branch prediction unit may use, among other mechanisms, a “stew”: information of an “address” (A) from which the instruction is coming, and the “history” (H), and hash these into a limited size table. The hashing mechanism should to be sufficiently simple to have cheap a hardware implementation, and have sufficiently good mixing properties to achieve a good distribution of guesses (i.e. assignments into the table). To illustrate the function of such a unit, consider a 32-bit address A, and an 8-bit history register H. Since typically the most significant bits of the address vary much more slowly than the least significant ones, a reasonable and cheap prediction can be achieved by Least_Signficant_Byte (A XOR H). In practice, Intel processors utilize more sophisticated mechanisms, but the above example suffices to illustrate how to disrupt such a mechanism.

To protect an application that requests such protection, a simple and cheap means is disrupting the branch predictor. This can be easily achieved by having a multiplexing bit that flushes the history register during operation. With “obscured” history, branch prediction becomes useless, and the miss-predictions do not provide information to an eavesdropping spy. Consequently, the protected application is slowed down, but its execution is more immune to timing based side channel that rely on branch miss-predictions.

The following are examples of side channel protections for a process that has executed a Security Hint instruction.

New Security Instruction with Multiple Leaves:

New Security Instruction Leaves to Setup Protected Cache Sections

A new security instruction is defined with the leaf number indicated by a general purpose register. Given leaves are defined to setup protected cache sections for various caches (L1 DCACHE, ICACHE, TRACE CACHE, L2 CACHE (MLC), LLC, L0 DTLB, L1 DTLB, L2 DTLB, ITLB, PDE CACHE, PDP CACHE, etc.). Other various parameters such as the memory address from where to copy data into protected cache sections, the protected cache section size, etc., are specified using other general purpose registers. The protected cache section allocation policies are micro-architectural specific and will include two new cache policies, split-cache policy and whole-cache policy. In split-cache policy, subsets of the cache structures are split between the logical processors naturally sharing that resource (logical processors residing on the same core or on different cores), and in whole-cache policy the entire protected cache section is available for a particular cache and is allocated for a single logical processor, while the non-protected cache sections will be left available for the other logical processors naturally sharing that cache.

The instruction leaf setting up a protected cache section for a particular cache will always rendezvous all logical processors naturally sharing that cache using micro-architectural events, and setup the cache according to the protected cache section allocation policy, flush the cache lines corresponding to this thread's protected cache section and load the data into the protected cache section from the specified memory address (where applicable) or just invalidate the protected cache section's contents. The successful allocation of the protected cache section will be indicated by setting this logical processor's per-cache protection flag. Where applicable, the protected cache section's physical address range, mask and valid fields (for data and instruction caches) are also set up. If the previous owner of the whole protected cache section loses ownership, its per-cache protection flag will be cleared (and the contents of its protected cache section flushed by the logical processor initiating the protected cache section setup) and the protected cache section's physical address range, mask and valid fields will be cleared. If a logical processor does not own its protected cache section for a particular cache as indicated by the corresponding protection flag and tries to access its resources, an exception will be generated to the OS kernel to inform it that a protected cache section allocation is required.

The successful allocation of the protected cache section will also result in saving this thread's CR3 system register value into per-cache scratchpad registers for later processing.

The mechanisms for detecting that a logical processor tries to access a particular protected cache section that it does not own are only active at ring 3 privilege level and are cache-specific. For data and instruction caches, if the physical address matches that of the protected cache section while the cache protected flag is cleared and the physical address range and mask valid flag is set causes a given OS exception. For other caches (DTLB, ITLB-related caches) a different exception is generated if the cache protected flag is cleared and a memory operation is attempted.

If a context switch occurs as indicated by a CR3 change, the per-cache protection flags corresponding to this logical processor will be set according to the match between the new CR3 and the per-cache scratchpad registers containing the values of CR3 at the time of per-cache protected cache section allocations, i.e. if they match, the per-cache protection flags will be set, otherwise they will be cleared.

New Security Instruction Leaves to Disable Protected Cache Sections

Given leaves are defined to disable the protected cache sections for various caches (L1 DCACHE, ICACHE, TRACE CACHE, L2 CACHE (MLC), LLC, L0 DTLB, L1 DTLB, L2 OTLB, ITLIB PDE CACHE, PDP CACHE, etc.).

The instruction leaf disabling a protected cache section for a particular cache will always rendezvous all logical processors naturally sharing that cache using micro-architectural events, setup the cache such that the protected cache section allocated to this logical processor is freed and its corresponding cache lines flushed (where applicable) or invalidated. The de-allocation of the protected cache section will be indicated by clearing this logical processor's per-cache protection and physical address and mask valid (where applicable) flags and invalidating the percache scratchpad register containing the CR3 value at the time of the protected cache section allocation.

This instruction leaf can be used by OS kernels when ending crypto-processes, when migrating threads to different processor cores or when performing task switches to other performance-critical processes.

Although the operations described herein may be described as a sequential process, some of the operations may in fat be performed in parallel or concurrently. In addition, in some embodiments the order of the operations may be rearranged.

The techniques described herein are not limited to any particular hardware or software configuration; they may find applicability in any computing or processing environment. The techniques may be implemented in hardware, software, or a combination of the two. The techniques may be implemented in programs executing on programmable machines such as mobile or stationary computers, personal digital assistants, set top boxes, cellular telephones and pagers, and other electronic devices, that each include a processor, a storage medium readable by the processor (including volatile and nonvolatile memory and/or storage elements), at least one input device, and one or more output devices. Program code is applied to the data entered using the input device to perform the functions described and to generate output information. The output information may be applied to one or more output devices. One of ordinary skill in the art may appreciate that the invention can be practiced with various computer system configurations, including multiprocessor systems, minicomputers, mainframe computers, and the like. The invention can also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine accessible medium having stored thereon instructions that may be used to program a processing system or other electronic device to perform the methods. The term “machine accessible medium” used herein shall include any medium that is capable of storing or encoding a sequence of instructions for execution by a machine and that cause the machine to perform any one of the methods described herein. The term “machine accessible medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system cause the processor to perform an action and produce a result.

What is claimed is:

1. A method comprising:
receiving a request to modify the operation of a processor to protect against side channel attacks; and
modifying branch prediction operation in response to the request.

2. The method of claim 1, wherein receiving the request includes recognizing a prefix to a branch instruction.

3. The method of claim 2, wherein modifying branch prediction operation includes disabling branch prediction logic.

4. The method of claim 3, wherein the prefix indicates whether a branch is to be speculatively taken.

5. The method of claim 3, wherein the prefix indicates that a branch should be speculatively taken at random.

6. The method of claim 3, wherein the prefix indicates that speculative execution is to be disabled.

7. The method of claim 3, further comprising disabling the updating of a branch prediction history data structure in response to receiving the request.

8. The method of claim 1, wherein receiving the request includes decoding a security hint instruction.

9. The method of claim 8, further comprising setting a flag in response to executing the security hint instruction.

10. The method of claim 6, wherein modifying branch prediction operation includes splitting a data structure that uses a shared resource.

11. The method of claim 10, wherein the shared resource is a branch prediction resource.

12. The method of claim 6, wherein modifying branch prediction operation includes erasing a data structure in response to a context switch.

13. The method of claim 1, wherein modifying branch prediction operation includes flushing a branch prediction history data structure.

14. An apparatus comprising:
execution logic to execute a branch instruction;
branch prediction logic to predict whether to take a branch in response to receiving the branch instruction; and
protection logic to modify operation of the branch prediction logic to protect against side channel attacks.

15. The apparatus of claim 14, wherein the protection logic is to modify operation of the branch prediction logic in response to the branch instruction including a prefix to indicate whether a branch is to be speculatively taken, that a branch is to be taken at random, or that speculation execution is to be disabled.

16. The apparatus of claim 14, wherein the protection logic is to modify operation of the branch prediction logic in response to receiving a security hint instruction.

17. The apparatus of claim 14, wherein the branch prediction logic includes a branch prediction history data structure and the protection logic is to disable updating of the branch prediction history data structure.

18. The apparatus of claim 14, wherein the protection logic is to modify operation of the branch prediction logic by splitting a shared branch prediction data structure.

19. The apparatus of claim 14, wherein the protection logic is to flush a branch prediction data structure.

20. A system comprising:
a memory to store a branch instruction; and
a processor including:
execution logic to execute the branch instruction;
branch prediction logic to predict whether to take a branch response to executing the branch instruction; and
protection logic to modify operation of the branch prediction logic to protect against side channel attacks.
